(19) United States
(12) Patent Application Publication
(10) Pub. No.: US 2024/0161023 A1
(43) Pub. Date: May 16, 2024

(54) DATA-DRIVEN SYSTEM AND DATA-DRIVEN METHOD BASED ON DATA-DRIVEN MODEL

(71) Applicants: Digiwin Software Co., Ltd, Shanghai (CN); DATA SYSTEMS CONSULTING CO., LTD., New Taipei City (TW)

(72) Inventors: Tzu-Chen Yeh, New Taipei City (TW); Hsiuchun Chen, New Taipei City (TW); Guoxin Sun, Shanghai (CN); Xiaoliang Ma, Shanghai (CN); Lei Feng, Shanghai (CN); Chu Yang Wang, Shanghai (CN)

(73) Assignees: Digiwin Software Co., Ltd, Shanghai (CN); DATA SYSTEMS CONSULTING CO., LTD., New Taipei City (TW)

(21) Appl. No.: 18/165,343

(22) Filed: Feb. 7, 2023

(30) Foreign Application Priority Data
Nov. 14, 2022 (CN) 202211424937.2

(51) Int. Cl. G06Q 10/0631

(52) U.S. Cl. CPC G06Q 10/06311

(57) ABSTRACT

The disclosure provides a data-driven system and a data-driven method based on a data-driven model. The data-driven system includes a storage device storing a data-driven module, a knowledge map module, and a data footprint module and a processor being coupled to the storage device. The processor executes the data-driven module to provide the current data status and feature description information corresponding to the changed business data to the knowledge map module. The processor executes the knowledge map module to analyze the current data status and feature description information, and returns the corresponding data-driven model to the data-driven module, and the data-driven module executes the task in the data-driven model. The processor executes the data footprint module to record the task execution result generated by the data-driven module executing the task.

### CROSS-REFERENCE TO RELATED APPLICATION

This application claims the priority benefit of China application serial no. 202211424937.2, filed on Nov. 14, 2022. The entirety of the above-mentioned patent application is hereby incorporated by reference herein and made a part of this specification.

### BACKGROUND

### Technical Field

The disclosure relates to a business data processing technology, and in particular, to a data-driven system and a data-driven method based on a data-driven model.

### Description of Related Art

There are various forms of data and business activities in enterprises, and most enterprises use systems to help employees complete their daily business. However, the current data is mainly entered into the system after the event or even just recorded offline. The system is passively operated by the user, or assists human in processing data rather than replacing humans. In other words, in the traditional business execution process, a large number of operations are actually initiated and completed manually. Therefore, how to enable the system to automatically drive the execution of business is one of the important topics in the field.

In addition, since there are many different management methods and management mechanisms in an enterprise, which often only exist in the brains of experienced personnel, there will be a problem of loss due to personnel turnover. In order to record and pass on the knowledge and experience of employees, a common practice in the existing technology is to establish an enterprise knowledge base, but there are problems of high threshold and long time-consumingness. Moreover, as the scale grows, it becomes more and more difficult to maintain. Another key problem of the existing technology is that knowledge may not be directly analyzed and used by the system automatically, and enterprises still rely on people to operate. Therefore, how to realize the effective depository, inheritance, and use of the business processing experience and business processing knowledge is also one of the important topics in the field.

### SUMMARY

The disclosure is directed to a data-driven system and a data-driven method based on a data-driven model, which may automatically drive corresponding business operations for changed business data.

According to an embodiment of the disclosure, a data-driven system of the disclosure includes a storage device storing a data-driven module, a knowledge map module, and a data footprint module and a processor being coupled to the storage device. The processor executes the data-driven module to provide the current data status and feature description information corresponding to the changed business data to the knowledge map module. The processor executes the knowledge map module to analyze the current data status and feature description information, and returns a corresponding data-driven model to the data-driven module. The data-driven module performs the task in the data-driven model. The processor executes the data footprint module to record the task execution result generated by the data-driven module executing the task.

According to an embodiment of the disclosure, a data-driven method based on a data-driven model of the disclosure includes the following. A data-driven module is executed through a processor to provide the current data status and feature description information corresponding to the changed business data to a knowledge map module. The knowledge map module is executed through the processor to analyze the current data status and feature description information, and the corresponding data-driven model is returned to the data-driven module. The task in the data-driven model is executed through the data-driven module. A data footprint module is executed through the processor to record the task execution result generated by the data-driven module executing the task.

Based on the above, the data-driven system and data-driven method based on the data-driven model of the disclosure may automatically initiate tasks for the changed business data to obtain the task execution result, and may effectively record the data processing history for future business tasks to use.

In order to make the above-mentioned features and advantages of the disclosure clearer and easier to understand, the following specific embodiments are given and described in details with the accompanying drawings as follows.

### BRIEF DESCRIPTION OF THE DRAWINGS

FIG. 1 is a schematic circuit diagram of a data-driven system according to an embodiment of the disclosure.

FIG. 2 is a schematic block diagram of a data-driven system according to an embodiment of the disclosure.

FIG. 3 is a flow diagram of a data-driven method according to an embodiment of the disclosure.

FIG. 4 is a schematic diagram of a system structure of a data-driven system according to an embodiment of the disclosure.

FIG. 5 is a schematic diagram of an operation of data pulling according to an embodiment of the disclosure.

FIG. 6 is a schematic diagram of an operation of data footprint recording according to an embodiment of the disclosure.

### DESCRIPTION OF THE EMBODIMENTS

Reference will now be made in detail to the exemplary embodiments of the disclosure, examples of which are illustrated in the accompanying drawings. Wherever possible, the same reference numbers are used in the drawings and the description to refer to the same or like parts.

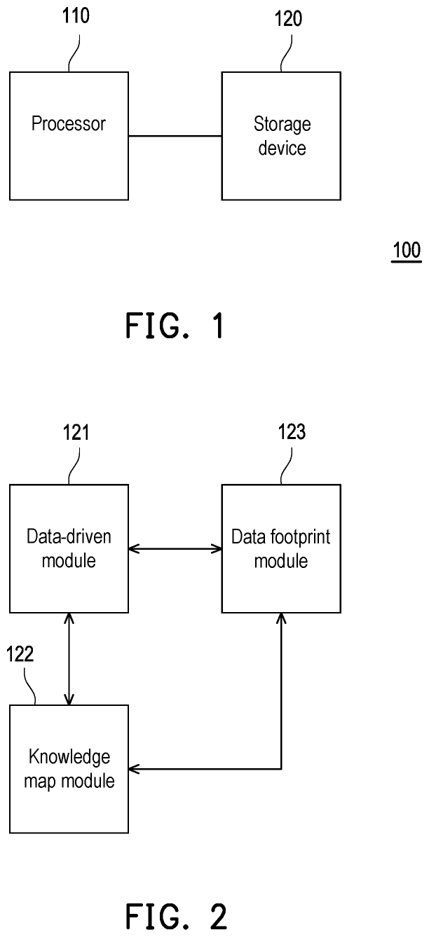

FIG. 1 is a schematic circuit diagram of a data-driven system according to an embodiment of the disclosure. FIG. 2 is a schematic block diagram of a data-driven system according to an embodiment of the disclosure. Referring to FIG. 1 and FIG. 2, a data-driven system 100 includes a processor 110 and a storage device 120. The processor 110 is coupled to the storage device 120. In the embodiment, the processor 110 may include, for example, a central processing unit (CPU), other programmable general purpose or special purpose microprocessors, digital signal processors (DSPs), application specific integrated circuits (ASICs), programmable logic devices (PLDs), other similar processing circuits, or a combination of these devices. The storage device 120 may include a memory and/or a database. The storage device 120 may store a data-driven module 121, a knowledge map module 122, and a data footprint module 123. The storage device 120 may be, for example, a non-volatile memory (NVM). The storage device 120 may store relevant programs, modules, systems, or algorithms for implementing various embodiments of the disclosure, so as to be accessed and executed by the processor 110 to implement the relevant functions and operations described in the various embodiments of the disclosure. In the embodiment, the data-driven system 100 implements them based on a data-driven model.

In the embodiment, the data-driven system 100 has a data-driven core composed of the data-driven module 121, the knowledge map module 122, and the data footprint module 123. The data-driven module 121, the knowledge map module 122, and the data footprint module 123 may be implemented, for example, in programming languages such as a JSON (JavaScript Object Notation), an extensible markup language (XML), or a YAML, but the disclosure is not limited thereto. In the embodiment, the data-driven system 100 may be disposed or built on a cloud server or a ground server, or may be disposed or built on the internal information system or the external information system of an enterprise. In an embodiment, the data-driven module 121, the knowledge map module 122, and the data footprint module 123 may also be stored in different storage devices, and the processor 110 may also include multiple processing units with data processing functions. The processor 110 and the storage device 120 may also be disposed in different servers or equipment. In the embodiment, the data-driven system 100 may be connected with the external service module and the external interactive system through wired connections and/or wireless connections, or connected with the external service module and external interactive system through the intranet and/or the Internet.

The aforementioned external service module may include, for example, a built-in customer relationship management (CRM) system, an enterprise resource planning (ERP) system, a manufacturing execution system (MES), and/or or a product lifecycle management (PLM) system, and may provide a variety of corresponding business service functions, and these services may be implemented, for example, based on a platform as a service (PAAS), a software as a service (SAAS), or other forms, and the disclosure is not limited thereto. The aforementioned external interactive system may include, for example, a user interface mounted on a terminal device, a man-machine interface, or an operation interface of an automation system, which may provide relevant task information, data, or requests to users.

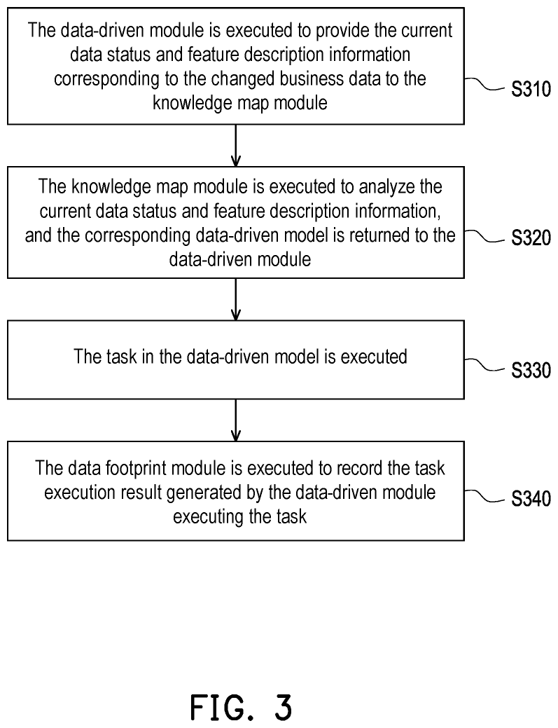

FIG. 3 is a flow diagram of a data-driven method according to an embodiment of the disclosure. Referring to FIG. 1 to FIG. 3, the data-driven system 100 may execute the following steps S310 to S340 to implement data driving. In the embodiment, the data-driven system 100 may obtain the changed business data, for example, through the external interactive system or the external service module. In an embodiment, the data-driven system 100 may further include a data change sensing module (a detection engine), and the data change sensing module may automatically detect whether there is changed business data in the external service module. Alternatively, the data-driven system 100 may also receive the changed business data input by the user through the external interactive system, or detect whether there is changed business data in the external interactive system through the data change sensing module. In the embodiment, the data-driven module 121 may obtain the changed business data, and implement data driving according to the changed business data. In step S310, the processor 110 may execute the data-driven module 121 to provide the current data status and feature description information corresponding to the changed business data to the knowledge map module 122. In step S320, the processor 110 may execute the knowledge map module 122 to analyze the current data status and feature description information, and return the corresponding data-driven model to the data-driven module 121. In step S330, the data-driven module 121 may execute the task in the data-driven model. In step S340, the processor 110 may execute the data footprint module 123 to record the task execution result generated by the data-driven module 121 executing the task.

The data-driven system 100 and the data-driven method of the embodiment may automatically initiate tasks for the changed business data to drive the associated business logic and execute the associated business operation, and may also automatically record the task execution result generated during the execution of the associated tasks.

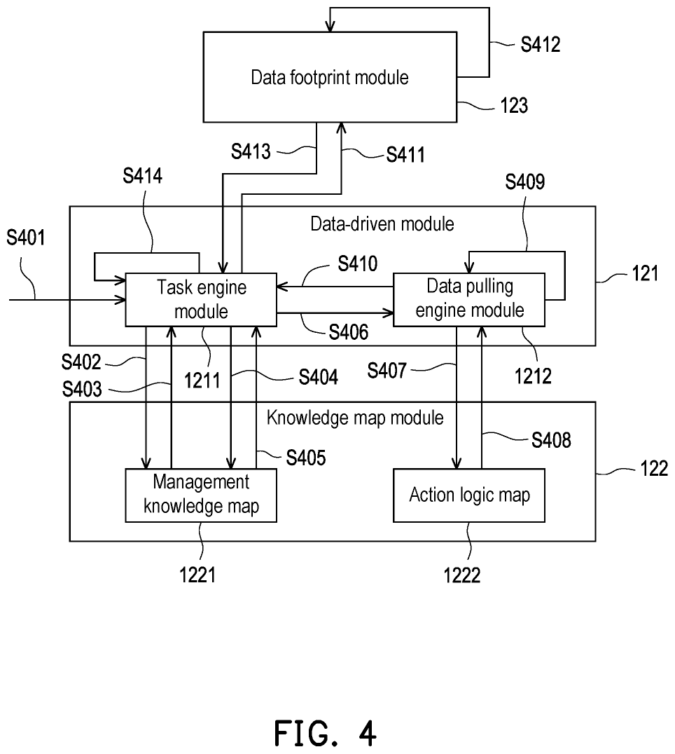

FIG. 4 is a schematic diagram of a system structure of a data-driven system according to an embodiment of the disclosure. Referring to FIG. 1 to FIG. 4, the embodiment further describes the specific module structure and implementation examples of the data-driven system 100. In the embodiment, the data-driven module 121 includes a task engine module 1211 and a data pulling engine module 1212. The knowledge map module 122 includes a management knowledge map 1221 and an action logic map 1222. The data-driven module 121, the knowledge map module 122, and the data footprint module 123 may execute the following operations S401 to S414. It should be noted that the operations S401 to S414 described below are not executed in complete order, but mainly describe the relevant operations and functions that may be executed and implemented by each module.

In operation S401, the task engine module 1211 may receive the changed business data. In operation S402, the task engine module 1211 may provide the corresponding event number to the management knowledge map 1221 of the knowledge map module 122 according to the changed business data. In operation S403, the task engine module 1211 may retrieve the item information according to the event number through the management knowledge map 1221, so that the management knowledge map 1221 returns the item information to the task engine module 1211. In step S404, the task engine module 1211 may obtain the current data status and feature description information corresponding to the changed business data according to the item information, and provide the current data status and feature description information to the management knowledge map 1221. In operation S405, the task engine module 1211 may analyze the current data status and feature description information through the management knowledge map 1221 to generate the data-driven model, so that the management knowledge map 1221 returns the data-driven model to the task engine module 1211. In this regard, in an embodiment, the task engine module 1211 may execute the task in the data-driven model to obtain another business data of the corresponding task execution result.

In operation S406, the task engine module 1211 may also provide the action number and the input parameter to the data pulling engine module 1212. In operation S407, the data pulling engine module 1212 may provide the action number and the context data description to the action logic map 1222 of the knowledge map module 122 according to the action number and the input parameter. In operation S408, the data pulling engine module 1212 may retrieve through the action logic map 1222 according to the action number, and analyze the context data description to generate the action logic, so that the action logic map 1222 may return the action logic to the data pulling engine module 1212. In step S409, the data pulling engine module 1212 may execute the action logic according to the action number and the input parameter to generate the target data. In step 410, the data pulling engine module 1212 may return the target data to the task engine module 1211. In this way, the task engine module 1211 may also match with the target data to execute the task in the data-driven model to generate the task execution result. In addition, the action logic described in the embodiment may also be implemented with the data-driven model.

In operation S411, the task engine module 1211 may provide the processing data generated during execution of the task to the data footprint module 123. In operation S412, the data footprint module 123 may associate the processing data with the corresponding historical data. That is to say, in operation S413, the task engine module 1211 may also obtain the previous processing data (may also be further matched with the target data) through the data footprint module 123 for executing the task in the data-driven model to generate task execution result. In operation S414, the task engine module 1211 may determine whether the business data of the task execution result is in the completed state. If the business data of the task execution result is in the completed state, then the task engine module 1211 may, for example, provide the task execution result to the external interactive interface to notify the user. If the business data of the task execution result is not in the completed state, the management knowledge map 1221 of the knowledge map module 122 may analyze the next business data of the task execution result through the knowledge map module 122 to obtain the next data status and next feature description information of the next business data, so that the management knowledge map 1221 of the knowledge map module 122 may return the corresponding next data-driven model to the task engine module 1211 of the data-driven module 121. In other words, the task engine module 1211 may execute the process of steps S404 to S413 again to gradually advance the task processing until the status and the feature of the business data reach the completed state. Therefore, the data-driven system 100 of the embodiment may automatically initiate tasks for the changed business data based on the enterprise management knowledge to drive the associated business logic and execute the associated business operation, so as to efficiently develop the business activities in the enterprise and enable the user (employee) to automatically obtain the to-do task based on the data change. In this way, the user (employee) may complete the task according to the system guideline and gradually achieve the business goal, thereby allowing the workload of the user (employee) to be effectively reduced while the business processing experience of the enterprise may be inherited at the same time.

In the embodiment, the management knowledge map 1221 and the action logic map 1222 may respectively be maps constructed based on the data-model-data (DMD) model, so as to implement operations such as retrieval, analysis, and conversion, in which the model may include the task, the action (action logic), or the item. Moreover, the management knowledge map 1221 and the action logic map 1222 may respectively define the operation logic of each model based on the enterprise management knowledge. For example, for specific documents (such as purchase requisitions, purchase orders, etc.), the corresponding operation logics may be defined so that the system may automatically execute these operation logics without manual operations by the experienced personnel.

In the embodiment, the task executed by the task engine module 1211 is a complete series of activities for business processing, and changes the status or the structure of the business data received before outputting. The data-driven model refers to a data logic structure of (input) data-task-(output) data for encapsulating the knowledge of enterprise business flow. The elements of the data (input data and output data) include data type (such as purchase requisition data), data status feature, and data structure. The elements of the task include input data and output data, and include one or more activities. The activities mentioned refer to the smallest matters that may be completed in one operation and may not be subdivided. For example, the input data may be a purchase order having been signed-off. The output data may be a purchase order having been replied. The task may include multiple activities, such as obtaining supplier information, sending emails, and responding to due dates. In this regard, the input data may be input into the task to implement the relevant business operations, and the corresponding output data may be output after the relevant business operations in the task are completed. In other words, the data-driven module 121 may execute the corresponding task according to the changed business data, so as to automatically execute the business task through the above-mentioned data-driven model, and obtain the task execution result (that is, the other business data expected to be obtained in the enterprise management or the operation). In addition, in the embodiment, the action logic executed by the data pulling engine module 1212 may be implemented by the data logic structure of the data (metadata)-action logic (action)-data (metadata).

For example, the task engine module 1211 may sense the new project event information generated by the external enterprise resource planning (ERP) generating the new project through the data change sensing module. The task engine module 1211 may find the corresponding item information in the management knowledge map 1221 of the knowledge map module 122 according to the new project event generated, and then retrieve the follow-up execution path according to the current data status (such as the project to be initiated) and the feature description information corresponding to the event, so as to obtain the execution path of the project and the follow-up task. Next, the task engine module 1211 may obtain the corresponding user of the person in charge of the EPR project as the person in charge of the project (the person in charge of the project needs to be obtained on the basis of the data existing), and construct the data with a specific structure. The data pulling engine module 1212 may obtain the action logic from the action logic map 1222 according to the action identifier and the existing data field. Moreover, after explaining the execution logic, the data pulling engine module 1212 may automatically call the employee-to-user interface through the action logic to return the user information corresponding to the ERP employee, and may construct the required data structure through mapping and return it to the task engine module 1211. Then, after the task engine module 1211 initiates the project, the data status may be changed (for example, changed to an initiated project) to continue to retrieve the follow-up execution path corresponding to the current data status, and a series of action data may be executed to make the status change (for example, to a project pending maintenance). In this regard, when the task engine module 1211 performs the project information maintenance task, the task engine module 1211 may notify the data footprint module 123 of the project number, the corresponding task name, and task status. After the maintenance of the project information is completed, the task engine module 1211 may change the data status (for example, to a project maintained), and update the corresponding task status of the project number recorded in the data footprint module 123 as completed. Moreover, the task engine module 1211 may also initiate the corresponding task according to the project information and record the data of the relevant item number and task number in the data footprint module 123. Finally, when the project is closed, the task engine module 1211 may find the corresponding task name recorded in the data footprint module 123 according to the project number and the ongoing task number, and perform a closing action to change the data status (for example, to a closed project).

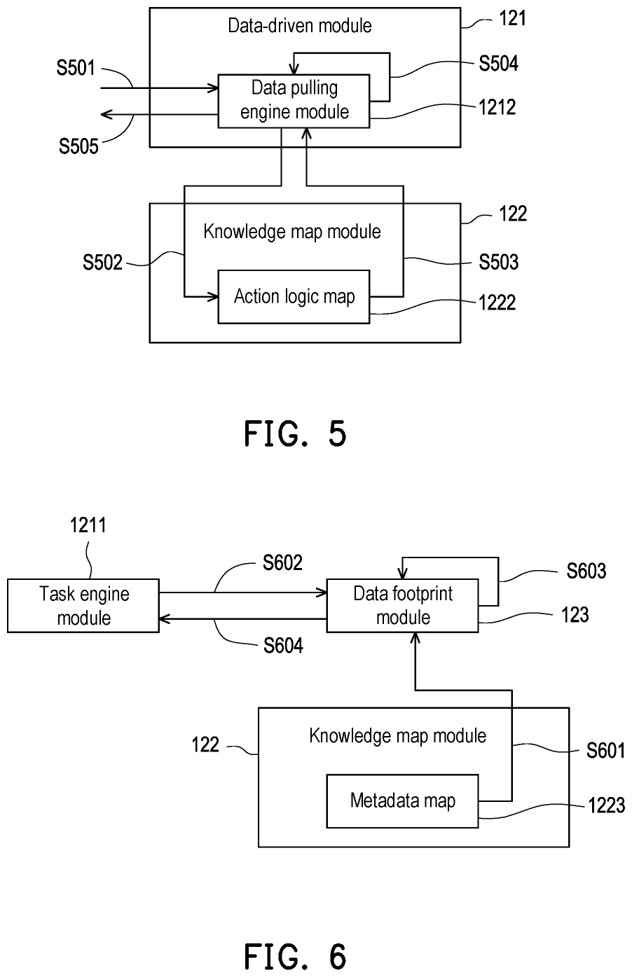

FIG. 5 is a schematic diagram of an operation of data pulling according to an embodiment of the disclosure. Referring to FIG. 1 to FIG. 3 and FIG. 5, the embodiment further illustrates a specific implementation manner of the data pulling engine module 1212. In the embodiment, the data pulling engine module 1212 may execute the following operations S501 to S505 to implement data pulling (pull data). In operation S501, the data pulling engine module 1212 may obtain the input parameter of the requested data description from the task engine module 1211, in which the input parameter may include, for example, a metadata representing the action number and the specific business data (i.e., the context data). The data pulling engine module 1212 may analyze the corresponding metadata based on the data and the action number, and may input the metadata into the action logic map 1222 to generate the data pulling execution path (the action logic). In operation S502, the data pulling engine module 1212 may provide the data description and the context data description. In the embodiment, the context data description is a kind of metadata, and may be used to describe the type and structure of the context data. In the embodiment, the context data is the environment data that may be obtained by the data pulling engine module 1212, for example, the data in the response information returned by the caller's previous business logic call service, or the currently logged-in user information or organization information, etc., which may all be used as the context data.

In operation S503, the data pulling engine module 1212 may retrieve according to the data description through the action logic map 1222, and analyze the context data description to generate the optional data pulling execution path (the action logic). The action logic map 1222 may return the optional data pull execution path (the action logic) to the data pulling engine module 1212. In the embodiment, the action logic map 1222 may be a business logic representation model based on the map model. That is, the business logic may be abstracted into the action to serve as the main node type in the map, and the data may be added as another main node type, so that the relationship between the action and the data may be described through the edge connecting the action node and the data node. Moreover, based on the characteristic of the map structure, multiple nodes may be connected arbitrarily, so as to better describe the logical correspondence between the action and the data, so that the existing functions of the information system, the operations requiring manual completion, and even more types of business logics are added to the action logic map. Moreover, various business logics applicable to different scenarios are also added to the action logic map, and may be freely combined according to the actual application scenario.

In step S504, the data pulling engine module 1212 may execute the data pulling execution path (the action logic) to obtain the target data (i.e., the requested data). In step S505, the data pulling engine module 1212 may output (return) the target data to the task engine module 1211, in which the target data may also be, for example, a metadata. Therefore, the data pulling engine module 1212 may implement an efficient data pulling operation to efficiently provide the associated metadata for use by the task engine module 1211 executing the task.

FIG. 6 is a schematic diagram of an operation of data footprint recording according to an embodiment of the disclosure. Referring to FIG. 1 to FIG. 3 and FIG. 6, the embodiment further illustrates a specific implementation manner of the data footprint module 123. In the embodiment, the data footprint module 123 may execute the following operations S601 to S604 to implement data footprint recording. In the embodiment, the knowledge map module 122 may further include a metadata map 1223. In operation S601, the metadata map 1223 of the knowledge map module 122 may provide the task and the business metadata definition of the data transformation to the data footprint module 123. In operation S602, the data footprint module 123 may obtain the business data and the data status (i.e., the processing data) of the current task execution result from the task engine module 1211. In operation S603, the data footprint module 123 may establish the status change history and the transformation relationship of the data according to the business metadata definition, the business data, and the data status (that is, associating the processing data with the corresponding historical data). In operation S604, the data footprint module 123 may provide the corresponding historical business data according to the requirement of the task engine module 1211. Therefore, the data footprint module 123 may implement the effective data processing history record, so as to effectively reduce the data processing amount of the task and speed up the execution speed of the task.

To sum up, the data-driven system and the data-driven method of the disclosure may automatically initiate tasks for the changed business data to drive the associated business logic and execute the associated business operation, and in particular, may associate the data and the associated task based on the enterprise management knowledge to automatically drive tasks directly related to the result of data change. The data-driven system and data-driven method of the disclosure may also effectively record the data processing history, so as to be used by the relevant business task to be executed later to reduce the amount of data calculation and increase the speed of data calculation. The data-driven system and data-driven method of the disclosure may implement the efficient business processing effect.

Finally, it should be noted that the above embodiments are only used to illustrate the technical solutions of the disclosure, but not to limit the technical solutions of the disclosure. Although the disclosure has been described in detail with reference to the foregoing embodiments, those skilled in the art should understand that the technical solutions described in the foregoing embodiments may still be modified, or some or all of the technical features thereof may be equivalently replaced. However, these modifications or substitutions do not make the essence of the corresponding technical solutions depart from the scope of the technical solutions of the embodiments of the disclosure.

What is claimed is:

1. A data-driven system based on a data-driven model, comprising:
a storage device, storing a data-driven module, a knowledge map module, and a data footprint module; and
a processor, coupled to the storage device,
wherein the processor executes the data-driven module to provide a current data status and feature description information corresponding to changed business data to the knowledge map module,
wherein the processor executes the knowledge map module to analyze the current data status and the feature description information, and returns the corresponding data-driven model to the data-driven module, and the data-driven module executes a task in the data-driven model,
wherein the processor executes the data footprint module to record a task execution result generated by the data-driven module executing the task.

2. The data-driven system according to claim 1, wherein the data-driven module comprises a task engine module, the data-driven module provides a corresponding event number to the knowledge map module according to the changed business data, and the knowledge map module returns item information to the task engine module according to the event number, so that the task engine module obtains the current data status and the feature description information corresponding to the changed business data according to the item information.

3. The data-driven system according to claim 2, wherein the knowledge map module comprises a management knowledge map, the management knowledge map retrieves the item information according to the event number, and the management knowledge map analyzes the current data status and the feature description information to generate the data-driven model.

4. The data-driven system according to claim 2, wherein the data-driven module further comprises a data pulling engine module, the task engine module provides an action number and an input parameter to the data pulling engine module, the data pulling engine module executes an action logic according to the action number and the input parameter to return a target data to the task engine module, and the task engine module executes the task according to the target data to generate the task execution result.

5. The data-driven system according to claim 4, wherein the input parameter comprises a metadata.

6. The data-driven system according to claim 4, wherein the data pulling engine module provides the action number and a context data description to the knowledge map module according to the action number and the input parameter, so that the knowledge map module returns the action logic to the data pulling engine module according to the action number and the context data description.

7. The data-driven system according to claim 6, wherein the knowledge map module comprises an action logic map, the action logic map retrieves according to the action number, and analyzes the context data description to generate the action logic.

8. The data-driven system according to claim 2, wherein the task engine module provides processing data generated during an execution of the task to the data footprint module, and the data footprint module associates the processing data with corresponding historical data.

9. The data-driven system according to claim 2, wherein the task engine module obtains previous processing data through the data footprint module for executing the task.

10. The data-driven system according to claim 2, wherein the task engine module analyzes next business data of the task execution result through the knowledge map module to obtain a next data status and next feature description information of the next business data, and returns a corresponding next data-driven model to the data-driven module, so that the data-driven module executes a next task in the next data-driven model.

11. A data-driven method based on a data-driven model, comprising:
executing a data-driven module through a processor to provide a current data status and feature description information corresponding to changed business data to a knowledge map module;
executing the knowledge map module through the processor to analyze the current data status and the feature description information, and returning the corresponding data-driven model to the data-driven module;
executing a task in the data-driven model through the data-driven module; and
executing a data footprint module through the processor to record a task execution result generated by the data-driven module executing the task.

12. The data-driven method according to claim 11, further comprising:
providing a corresponding event number to the knowledge map module through a task engine module of the data-driven module according to the changed business data;
returning item information to the task engine module through the knowledge map module according to the event number; and
obtaining the current data status and the feature description information corresponding to the changed business data through the task engine module according to the item information.

13. The data-driven method according to claim 12, wherein the knowledge map module comprises a management knowledge map, the item information is retrieved by the management knowledge map according to the event number, and the current data status and the feature description information are analyzed by the management knowledge map to generate the data-driven model.

14. The data-driven method according to claim 12, wherein steps to execute the task in the data-driven model comprise:
providing an action number and an input parameter to a data pulling engine module of the data-driven module through the task engine module of the data-driven module;
executing an action logic through the data pulling engine module according to the action number and the input parameter to return target data to the task engine module; and
executing the task through the task engine module according to the target data to generate the task execution result.

15. The data-driven method according to claim 14, wherein the input parameter comprises a metadata.

16. The data-driven method according to claim 14, wherein the steps to execute the task in the data-driven model further comprise:
providing the action number and a context data description to the knowledge map module through the data pulling engine module according to the action number and the input parameter; and
returning the action logic to the data pulling engine module through the knowledge map module according to the action number and the context data description.

17. The data-driven method according to claim 16, wherein the knowledge map module comprises an action logic map, a retrieval is made by the action logic map according to the action number, and the context data description is analyzed to generate the action logic.

18. The data-driven method according to claim 12, further comprising:
providing processing data generated during an execution of the task to the data footprint module through the task engine module; and
associating the processing data with corresponding historical data through the data footprint module.

19. The data-driven method according to claim 12, wherein the steps to execute the task in the data-driven model comprises:
obtaining previous processing data through the data footprint module by the task engine module for executing the task.

20. The data-driven method according to claim 12, further comprising:
analyzing next business data of the task execution result through the knowledge map module by the task engine module to obtain a next data status and next feature description information of the next business data, and returning a corresponding next data-driven model to the data-driven module; and
executing a next task in the next data-driven model through the data-driven module.
